(19) United States
(12) Patent Application Publication
(10) Pub. No.: US 2024/0211701 A1
(43) Pub. Date: Jun. 27, 2024

(54) AUTOMATIC ALTERNATIVE TEXT SUGGESTIONS FOR SPEECH RECOGNITION ENGINES OF CONTACT CENTER SYSTEMS

(71) Applicant: Genesys Cloud Services, Inc., Menlo Park, CA (US)

(72) Inventors: Lev Haikin, Tel Aviv (IL); Avraham Faizakof, Tel Aviv (IL); Rotem Maoz, Tel Aviv (IL); Eyal Orbach, Tel Aviv (IL); Nelly David, Tel Aviv (IL)

(21) Appl. No.: 18/088,230

(22) Filed: Dec. 23, 2022

(51) Int. Cl. G06F 40/40; G06F 40/166; G06F 40/279; G10L 15/22; G10L 15/26

(52) U.S. Cl. CPC G06F 40/40; G06F 40/166; G06F 40/279; G10L 15/22; G10L 15/26

(57) ABSTRACT

A method for generating automatic alternative text suggestions for a speech recognition engine of a contact center system according to an embodiment includes applying a word embedding model to generate a vector representation of each unique word in a contact center communication text corpus, calculating a cosine similarity of each vector representation and each other vector representation generated by the word embedding model, discarding each calculated cosine similarity result determined to be below a predefined threshold to generate a filtered set of word pairs, calculating a Levenshtein distance between words of each word pair of the filtered set of word pairs, and generating a candidate list of alternative words for a target word based on the Levenshtein distance between the words of each word pair of the filtered set of word pairs.

### BACKGROUND

Automatic speech recognition systems are used in a wide array of fields. For example, in contact center systems, automatic speech recognition may be used for enabling further analysis of customer-agent interactions such as phrase spotting, sentiment analysis, personally identifiable information (PII) redaction, document searching, and various other purposes. Although such systems perform well overall, it is common for mistakes to be found in the speech-to-text conversion, for example, due to misrecognized or misinterpreted words (e.g., “i phone” compared to “iphone”). These misrecognized or misinterpreted words may be corrected during a post-processing phase using a predefined set of “sounds like” pairs of incorrect and correct forms. However, in order to do so, there is a need to identify and compile a list of sounds-like candidates for specific words of interest. The traditional approach is to manually iterate over bulk transcription results, identify recognition mistakes, and add these “sounds like” pairs to the list.

### SUMMARY

One embodiment is directed to a unique system, components, and methods for generating automatic alternative text suggestions for a speech recognition engine of a contact center system. Other embodiments are directed to apparatuses, systems, devices, hardware, methods, and combinations thereof for generating automatic alternative text suggestions for a speech recognition engine of a contact center system.

According to an embodiment, a method for generating automatic alternative text suggestions for a speech recognition engine of a contact center system may include applying a word embedding model to generate a vector representation of each unique word in a contact center communication text corpus, calculating a cosine similarity of each vector representation and each other vector representation generated by the word embedding model, discarding each calculated cosine similarity result determined to be below a predefined threshold to generate a filtered set of word pairs, calculating a Levenshtein distance between words of each word pair of the filtered set of word pairs, and generating a candidate list of alternative words for a target word based on the Levenshtein distance between the words of each word pair of the filtered set of word pairs.

In some embodiments, the word embedding model may be or include a word2vec model.

In some embodiments, the method may further include identifying at least one word collocation in the text corpus and replacing each word collocation of the at least one word collocation in the text corpus with a respective modified unigram, and wherein applying the word embedding model may include applying the word embedding model in response to identifying the at least one word collocation in the text corpus and replacing each word collocation of the at least one word collocation in the text corpus with the respective modified unigram.

In some embodiments, generating the candidate list of alternative words for the target word may include replacing each modified unigram with a respective original word collocation.

In some embodiments, the method may further include sorting the candidate list of alternative words for the target word based on the Levenshtein distance between the words of each word pair of the filtered set of word pairs, displaying the sorted candidate list to the user, and receiving the user's selection of one or more alternative words from the candidate list to be used as alternative text for the target word in the speech recognition engine of the contact center system.

In some embodiments, the method may further include automatically selecting, based on the Levenshtein distance between the words of each word pair of the filtered set of word pairs, one or more alternative words from the candidate list as alternative text for the target word in the speech recognition engine of the contact center system.

In some embodiments, the method may further include determining a number of occurrences in the text corpus of each word of the filtered set of word pairs.

In some embodiments, generating the candidate list of alternative words for the target word may include generating the candidate list of alternative words for the target word based on the Levenshtein distance between the words of each word pair of the filtered set of word pairs and the number of occurrences in the text corpus of each word of the filtered set of words.

In some embodiments, the method may further include automatically generating a plurality of transcripts of the contact center communication text corpus using greedy decoding.

In some embodiments, the method may further include automatically generating a plurality of transcripts of the contact center communication text corpus using prefix-beam decoding.

In some embodiments, generating the candidate list of alternative words for the target word may include generating the candidate list of alternative words for the target word in response to receiving a user request for alternative words for the target word.

According to another embodiment, a computing system for generating automatic alternative text suggestions for a speech recognition engine of a contact center system may include at least one processor and at least one memory comprising a plurality of instructions stored thereon that, in response to execution by the at least one processor, causes the computing system to apply a word embedding model to generate a vector representation of each unique word in a contact center communication text corpus, calculate a cosine similarity of each vector representation and each other vector representation generated by the word embedding model, discard each calculated cosine similarity result determined to be below a predefined threshold to generate a filtered set of word pairs, calculate a Levenshtein distance between words of each word pair of the filtered set of word pairs, and generate a candidate list of alternative words for a target word based on the Levenshtein distance between the words of each word pair of the filtered set of word pairs.

In some embodiments, the word embedding model may be or include a word2vec model.

In some embodiments, the plurality of instructions may further cause the computing system to identify at least one word collocation in the text corpus and replace each word collocation of the at least one word collocation in the text corpus with a respective modified unigram, and to apply the word embedding model may include to apply the word embedding model in response to identification of the at least one word collocation in the text corpus and replacement of each word collocation of the at least one word collocation in the text corpus with the respective modified unigram.

In some embodiments, to generate the candidate list of alternative words for the target word may include to replace each modified unigram with a respective original word collocation.

In some embodiments, the plurality of instructions may further cause the computing system to sort the candidate list of alternative words for the target word based on the Levenshtein distance between the words of each word pair of the filtered set of word pairs, display the sorted candidate list to the user, and receive the user's selection of one or more alternative words from the candidate list to be used as alternative text for the target word in the speech recognition engine of the contact center system.

In some embodiments, the plurality of instructions may further cause the computing system to automatically select, based on the Levenshtein distance between the words of each word pair of the filtered set of word pairs, one or more alternative words from the candidate list as alternative text for the target word in the speech recognition engine of the contact center system.

In some embodiments, the plurality of instructions may further cause the computing system to determine a number of occurrences in the text corpus of each word of the filtered set of word pairs.

In some embodiments, to generate the candidate list of alternative words for the target word may include to generate the candidate list of alternative words for the target word based on the Levenshtein distance between the words of each word pair of the filtered set of word pairs and the number of occurrences in the text corpus of each word of the filtered set of words.

In some embodiments, the plurality of instructions may further cause the computing system to automatically generate a plurality of transcripts of the contact center communication text corpus using greedy decoding.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIG. 3 is a simplified flow diagram of at least one embodiment of a method for identifying alternative words for various target words;

FIG. 4 is a simplified flow diagram of at least one embodiment of a method for providing candidate alternative words to a user for a specific target word; and

FIG. 5 illustrates a sample excerpt of data output from execution of the methods of FIGS. 3-4.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

It should be appreciated that, during automatic speech recognition and in near real-time, a speech-to-text engine may automatically transcribe spoken utterances into textual form. However, in doing so, there are often mistakes due to technical limitations of the system, noise, strong user accents, objectively difficult words to pronounce, mixed language dialogue (e.g., a user uttering an English word during a predominantly Spanish conversion), and other reasons. One such type of error involves the transcription of a word to another word that sounds like the correct word. For example, the resultant text may erroneously recite “i phone” instead of “iphone.” Similarly, the resultant text may read “gen sys” or “jesus” instead of “genesys” due to acoustic similarities. Accordingly, alternative text pairs (also referred to as “sounds like” pairs) may be compiled and used by the computing system to correct such errors during a post-processing step of the transcription. However, creating such “sounds like” pairs is not an intuitive task and typically involves the time consuming process of an administrative user reviewing a corpus of transcription results to identify errors and manually create pairs with alternative text.

It should be appreciated that the technologies described herein take a more elegant and innovative approach to the generation of alternative text for a specific target word (e.g., in generating “sounds like” pairs). As described in greater detail below, the computing system may apply a word embedding model (e.g., word2vec) to generate a vector representation of each unique word in a text corpus related to communications within a contact center, calculate a cosine similarity of each vector representation and each other vector representation generated by the word embedding model and discard those below a predefined threshold (e.g., 0.45), calculate a Levenshtein distance between words for each of the remaining word pairs, and sort the results by ascending Levenshtein distances, for example, for user or automated selection.

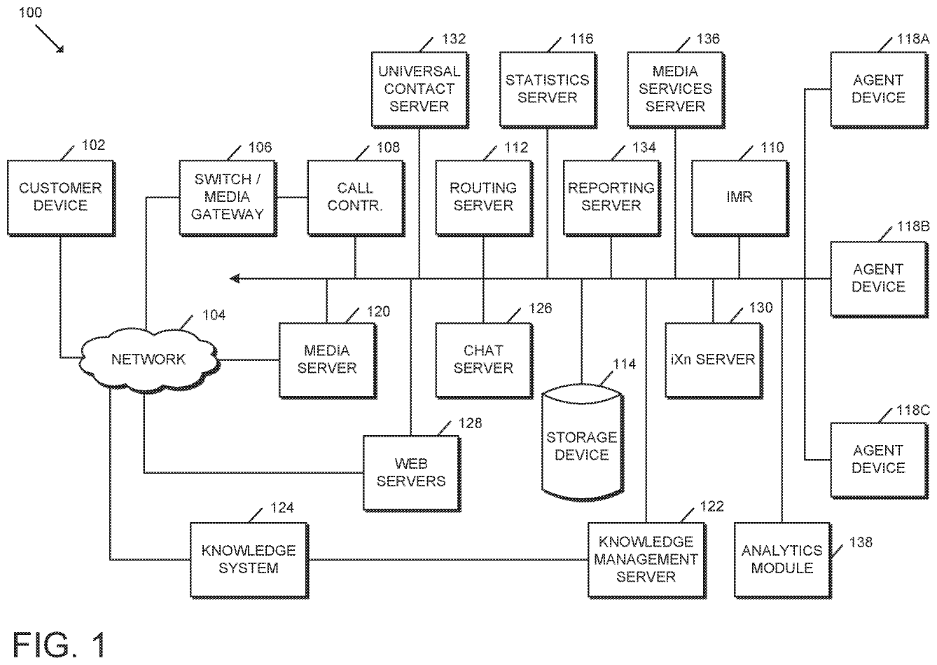

Referring now to FIG. 1, a simplified block diagram of at least one embodiment of a communications infrastructure and/or content center system, which may be used in conjunction with one or more of the embodiments described herein, is shown. The contact center system 100 may be embodied as any system capable of providing contact center services (e.g., call center services, chat center services, SMS center services, etc.) to an end user and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VOIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

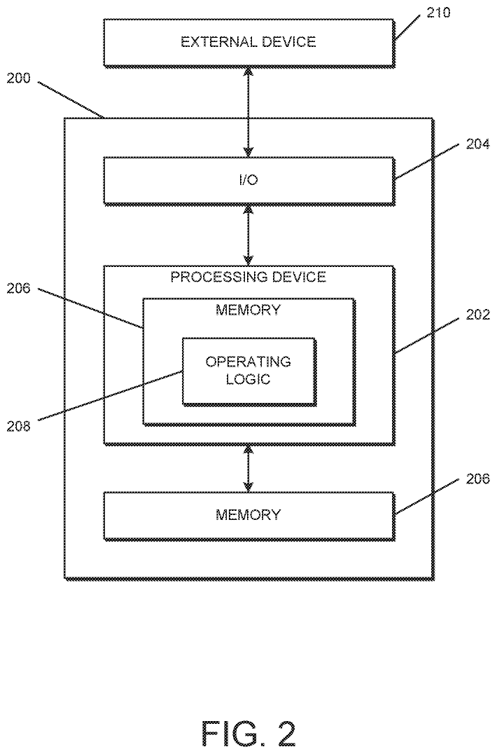

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VOIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VOIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VOIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein-such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IOT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

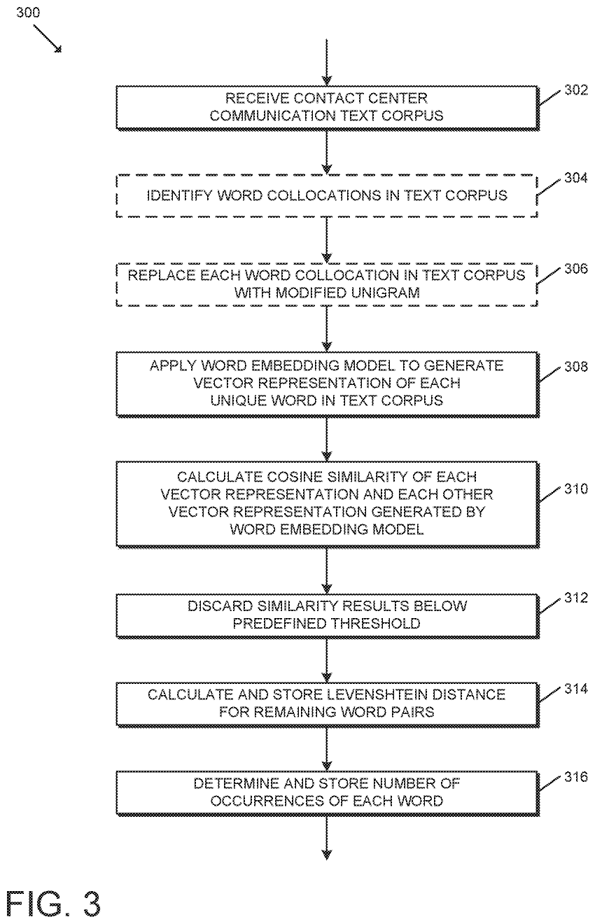

Referring now to FIG. 3, in use, a computing system (e.g., the contact center system 100 and/or computing device 200) may execute a method 300 for identifying alternative words for various target words. It should be appreciated that the particular blocks of the method 300 are illustrated by way of example, and such blocks may be combined or divided, added or removed, and/or reordered in whole or in part depending on the particular embodiment, unless stated to the contrary.

The illustrative method 300 begins with block 302 in which the computing system receives a contact center communication text corpus. It should be appreciated that a large number of transcriptions are typically abundant in cloud-based contact center systems (e.g., the contact center system 100), and the number of communications received by the computing system for analysis may vary depending on the particular embodiment. For example, in some embodiments, the text corpus received for analysis may include one hundred thousand or more conversational recordings from the same business/domain. It should be further appreciated that the transcriptions may be generated in the first instance using a greedy decoding algorithm and/or a prefix-beam decoding algorithm depending on the particular embodiment.

In block 304, the computing system may identify any word collocations in the text corpus and, in block 306, the computing system may replace each of the identified word collocations in the text corpus with a modified unigram. It should be appreciated that a collocation is a sequence of words (e.g., a pair of words) that often appear together in text but are representative of a single semantic unit. For example, some common collocations include “new york”, “fast food”, “step up”, and others. In some embodiments, the computing system utilizes pointwise mutual information (PMI) to discover collocations in the text corpus. However, it should be further appreciated that the computing system may utilize any suitable algorithm and/or technologies for identifying word collocations. In some embodiments, in replacing a word collocation with a modified unigram, the computing system may replace a space between the words in the collocation with an underscore character (or other character that is not a candidate for transcription) to generate a modified unigram, and replace each instance of the collocation in the text corpus with the modified unigram. For example, the computing system may replace each instance of “new york” in the text corpus with “new_york”. By doing so, it should be appreciated that the computing system prevents subsequent tokenization of the collocation into two distinct words.

In block 308, the computing system applies a word embedding model (e.g., word2vec) to generate a vector representation of each unique word in the text corpus. It should be appreciated that word2vec and/or other word embedding models may create a mathematical representation for each unique word in the text corpus in the form of a vector. As such, for simplicity and brevity of the description, the terms “string,” “word,” “vector,” and “vector representation” may be used interchangeably unless expressly stated to the contrary or the context otherwise dictates. It should be further appreciated that, in the illustrative embodiment, each unique word is assigned its own vector representation, such that if a word is used multiple times in the text corpus, each instance of that word is assigned the same vector representation. Accordingly, regardless of the size of the text corpus, the word embedding model (e.g., word2vec) outputs a vocabulary or list of words used in the text corpus along with, or as, the respective vector representations. Further, in generating a vector representation, the word embedding model is able to evaluate the context of a particular word based, for example, on its prior usage and association with other words.

In block 310, the computing system calculates a cosine similarity (inner product) of each vector representation and each other vector representation generated by the word embedding model (e.g., word2vec). It should be appreciated that the cosine similarity of any two such vectors results in a number between −1 and +1, because the vectors are normalized to be of length l. Further, due to the manner in which the word embedding model generates the vector representation of words in the text corpus (e.g., based on context, word associations, and other features), the cosine similarity of similar words such as synonyms (e.g., “doctor” and “physician”) is generally close to 1 (e.g., 0.95) due to the similarities, whereas the cosine similarity of words that have orthogonal meanings may be close to 0 or even negative.

In block 312, the computing system discards each of the calculated cosine similarity results that falls below a predefined threshold (e.g., resulting in a reduced or filtered set of possible word pairs). For example, in some embodiments, the predefined threshold may be 0.45, such that any word pairs that have a cosine similarity below 0.45 are deleted/discarded from further analysis.

In block 314, the computing system calculates and stores the Levenshtein distance between words for each word pair of the remaining words (e.g., for each word pair in the filtered set of possible word pairs). In other words, the computing system determines the Levenshtein distance between each word and each other word remaining after filtering out word pairs that have a cosine similarity below the predefined threshold. It should be appreciated that the Levenshtein distance takes two strings/words as an input and outputs a number indicating the distance between those two strings/words. The distance is calculated as the number of changes between the two words, which come in three forms-a letter substitution (e.g., replacing “g” with “d”), an omission of a character, or an insertion of a character. It should be appreciated that the words with a small Levenshtein distance are more likely to be misspellings (i.e., one being a misspelling of the target word) than words with a large Levenshtein distance. Although the illustrative embodiment describes using the Levenshtein distance, it should be appreciated that the computing system may utilize one or more different metrics for computing the distance between (or similarity between) two words in other embodiments.

In block 316, the computing system determines (e.g., counts) and stores the number of occurrences in the text corpus of each of the words (e.g., each remaining word after the filtering due to the predefined threshold described above).

Although the blocks 302-316 are described in a relatively serial manner, it should be appreciated that various blocks of the method 300 may be performed in parallel in some embodiments.

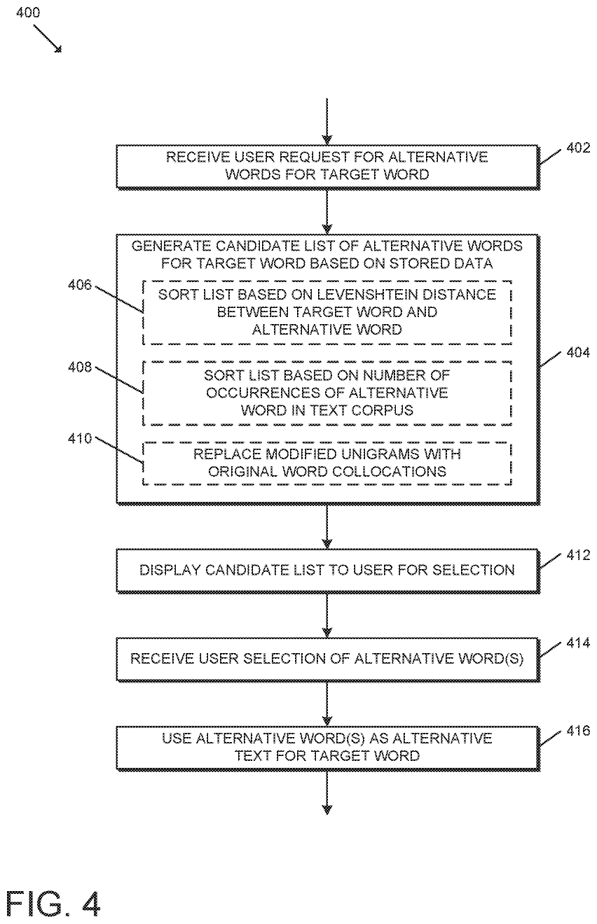

Referring now to FIG. 4, in use, a computing system (e.g., the contact center system 100 and/or computing device 200) may execute a method 400 for providing candidate alternative words to a user for a specific target word. It should be appreciated that the particular blocks of the method 400 are illustrated by way of example, and such blocks may be combined or divided, added or removed, and/or reordered in whole or in part depending on the particular embodiment, unless stated to the contrary. It should be further appreciated that, in some embodiments, execution of the method 400 of FIG. 4 may rely on data stored in conjunction with various analytics performed during execution of the method 300 of FIG. 3 described above.

The illustrative method 400 begins with block 402 in which the computing system receives a user request for alternative words for a particular target word. In other words, the user may request a list of “sounds like” pairs for a specific word of interest. For example, the user may be interested in identifying possible misspellings or acoustic variations of the word “dodgers” and therefore may request that the computing system generate a set of prospective alternative words to “dodgers”.

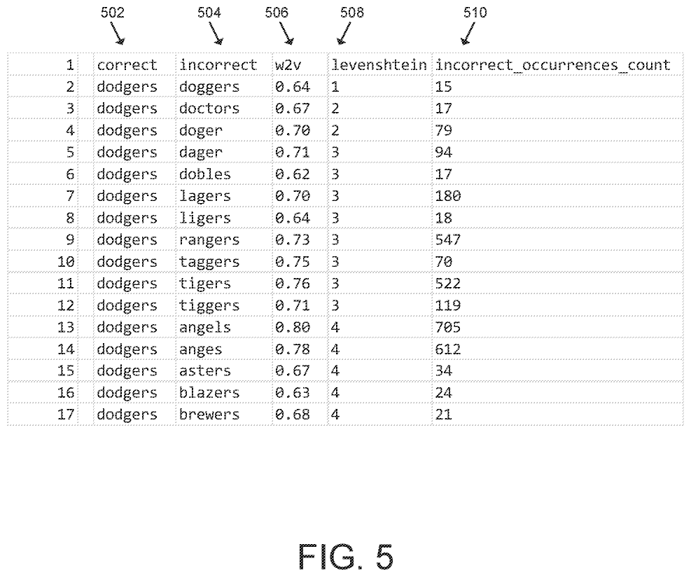

In block 404, the computing system generates a candidate list of alternative words for the target word based on the Levenshtein distance between the target word and alternative words, the number of occurrences of the alternative word in the text corpus, and/or other stored data. In particular, in block 406, the computing system may sort the candidate list based on the Levenshtein distance between the target word and the various other alternative words. More specifically, in some embodiments, the alternative words may be sorted by ascending Levenshtein distance as shown in reference to FIG. 5. In block 408, the computing system may sort the list based on the number of occurrences in the text corpus of each alternative word. For example, the alternative words may be sorted by descending number of occurrences, such that the most commonly recited words appear first. In some embodiments, the priorities, recommendations, and/or sorting of alternative words may be based on both the Levenshtein distance and word frequency (i.e., number of occurrences). In block 410, the computing system may replace any modified unigrams described above (e.g., “new_york”) with the original word collocations (e.g., “new york”), for example, before presenting the data to the user or otherwise using the data.

In block 412, the computing system displays the candidate list to the user and, in block 414, the computing system receives the user's selection of one or more alternative words. In block 416, the computing system may use the selected alternative word(s) as alternative text for the target word, for example, when post-processing the transcribed text to automatically correct speech-to-text errors as described above. Further, although the alternative words are described as being user selected, it should be appreciated that the computing system may automatically select one or more alternative words in other embodiments. For example, in some embodiments, the computing system may automatically select one or more alternative words that have a Levenshtein distance to the target word that is within a predefined threshold Levenshtein distance (e.g., 2 or 3).

Although the blocks 402-416 are described in a relatively serial manner, it should be appreciated that various blocks of the method 400 may be performed in parallel in some embodiments.

FIG. 5 illustrates a sample excerpt of data output from execution of the method 300 of FIG. 3 and the method 400 of FIG. 4. The output data includes a column 502 that identifies the target word, a column 504 that identifies the corresponding alternative word, a column 506 that identifies the corresponding cosine similarity of the vector representations, a column 508 that identifies the corresponding Levenshtein distance, and a column 510 that identifies the number of occurrences of the alternative word in the text corpus. In the illustrative embodiment, assume that the computing system has already performed greedy-decoding speech recognition of approximately one hundred thousand conversational recordings from the same business/domain. Further, in the illustrative embodiment, the computing system has compiled a list of word pairs having a word2vec cosine similarity score of 0.45 or greater, and the word “dodgers” has been selected as the target word. In this example, approximately 299 word pairs remained, which consisted of different sport team names and likely misspellings, which makes sense as such words tend to appear in similar context (and therefore are likely to have high cosine similarity scores with the target word). Further, as shown, the results were sorted by ascending Levenshtein distance. It should be appreciated that the first five candidates are recognizable misspellings of the target word. Through experimentation, these five candidates were used to execute beam decoding with the “sounds like” algorithm described in substantial below on a manually transcribed test set. The word “dodgers” had a baseline recall of 0.500, which increased to 0.833 with the addition of the alternative words, while the precision remained at 1.000.

As described above, it should be appreciated that the automatically generated transcriptions themselves may be based on the results of greedy decoding or on the results of prefix-beam-decoding, for example, where the output is constrained/limited to known vocabulary only (which may perform better in terms of word-error-rate), or both.

Prefix-beam-decoders are often implemented using online beam unfolding, maintaining a pre-specified maximum number of beams at each time-step. A beam is a sequence of characters typically implemented using a tree (prefix-tree) structure where child nodes maintain a pointer to their direct ancestor node. As such, beams with the same prefixes share the same ancestor nodes chain. The input is typically a matrix of character distributions per time-step, and characters could be the English alphabet, space, apostrophe, and a special “blank” character. Such a matrix may be produced using a pre-trained neural-network, for example, given some audio signal as input. The prefix-beam-search may iterate over the given time-steps, and a list of beams may be maintained throughout the iteration process. At each time-step, each beam in the list may be extended to any possible character in the list of characters in the matrix corresponding to the current time-step. Further, pruning may be performed for very low-probability characters, and for beams that, upon extension, lead to sequences that are out-of-vocabulary.

In some embodiments, each beam is assigned a score that is the product of the probability of the character extending the beam and the stored beam score prior to applying the character extension. Beams that have the same underlying sequence (after same-character removal and “blank” removal) are merged, except for beams that end with “blank”. The remaining list of beams may be reduced to top-k beams (k being the maximum beam width), and the process may repeat until no more time-steps remain in the input matrix.

A language model is often used during the iterative process, and for each beam that ends with a space, a language-model score may be computed for the n-gram represented by the beam. This score may be added to the beam score multiplied by some hyper-parameter alpha (i.e., a normalization factor). In some embodiments, a sentence length penalty hyper-parameter may also be added. Upon completion, beams that are on the final list are traversed back to the root node, generating offsets/time-steps and durations of characters on the beam. It should be appreciated that time-steps and durations are used for computing word start/end time marks as well as word confidence values, among other features.

In some embodiments, it should be appreciated that the prefix-beam-decoder algorithm descried above may be modified for “sounds like” alternative text analysis as described below. For each beam in each time-step, the computing system applies traversal towards the root node. In tandem, the computing system applies a second traversal of a Trie structure (e.g., prepared in advance) that holds all incorrect forms of “sounds like” word pairs (e.g., stored in reverse order). This parallel traversal may continue as long as the character on the beam leads to a “legal” node on the “sounds like” Trie, skipping repetitions and blanks. If at some point they are not, this process stops. It should be appreciated that a Trie accepts if it gets through to the end of at least one of the stored sequences. In the example above, this means that there is a path (e.g., for “doggers”) in the beams. Upon acceptance, the computing system builds an “artificial” beam starting from the node that precedes the node upon which the traversal ended on. This beam would end up having the same prefix as the original beam. It would, however, hold the correct form associated with the “accepted” incorrect form as specified in the “sounds like” pair. This association could be realized by storing the correct form as a “payload” of the last node of the Trie chain. It should be appreciated that such a node is unique for each incorrect form Trie-chain. The payload is then taken and “pasted” starting from the aforementioned node. This artificial beam is given the same score as the original beam, and it is then added to the list of beam candidates and processed as a regular beam (e.g., merge, prune etc.). This process adds a new beam to the list of beams in addition to the original beam.

At this point, there is a non-zero chance that the artificial beam containing the correct form (which otherwise might not have even been considered) would “bubble-up” to the top while still giving the original beam a chance to survive as well. The outcome now depends on external scorers (e.g., a language-model score that can further boost the correct beam given n-gram statistics) or using a boost mechanism (e.g., using a similar technique to parallel beam/Trie unfolding to boost the existing accepted beam score with some predefined value).

It should be appreciated that some edge cases may be considered and streamlined. For example, when there are several correct forms for the same incorrect form, the computing system may maintain a list and iterate over it. Additionally, when the correct form is longer than the incorrect form, this may be successfully mitigated by the prevalence of blank characters. If the incorrect sequence is longer even with blanks, then the artificial beam may be discarded. In the opposite case when the correct form is shorter (which is often the case), then blanks-padding may be added to the artificial beam. The incorrect form may also be added to the allowed vocabulary so that the beam holding this incorrect form would not get pruned in the preliminary stage. To force whole words substitution, space padding can be added around the correct and incorrect forms. It should be further appreciated that modifications can be made to address the beginning and end of a sentence in which there is no space before the word and no trailing space, respectively. Specifically, a special start-node may be checked against a potential space padding to handle the start of a sentence, and an artificial space beam node may be added (and subsequently removed) to address the end of a sentence. A beam ending with many blanks can lead to excessive iterations and additions of artificial beams, and therefore such issues may be avoided by starting traversal only if an end of beam character leads to a “legal” node in the “sounds like” Trie.

Because different “sounds like” implementations are aimed at recovering important words by exploiting the observation that recognition mistakes are repetitive to some degree, going “deeper” utilizes this property even further by considering different variations of recognition mistakes for the same utterance, which otherwise (e.g., in a post-processing method) would have been “invisible.” More concretely, consider the case where at least one of the beams contains a “common” mistake that happens to have a predefined “sounds like” pair, and assume that this specific beam is not preserved due to a lower score. This means that the final transcription will not include this beam but will include some other beam that is different. Although post processing cannot recover this beam/word, the described “deeper” approach might recover it.

What is claimed is:

1. A method for generating automatic alternative text suggestions for a speech recognition engine of a contact center system, the method comprising:
applying a word embedding model to generate a vector representation of each unique word in a contact center communication text corpus;
calculating a cosine similarity of each vector representation and each other vector representation generated by the word embedding model;
discarding each calculated cosine similarity result determined to be below a predefined threshold to generate a filtered set of word pairs;
calculating a Levenshtein distance between words of each word pair of the filtered set of word pairs; and
generating a candidate list of alternative words for a target word based on the Levenshtein distance between the words of each word pair of the filtered set of word pairs.

2. The method of claim 1, wherein the word embedding model comprises a word2vec model.

3. The method of claim 1, further comprising identifying at least one word collocation in the text corpus and replacing each word collocation of the at least one word collocation in the text corpus with a respective modified unigram; and
wherein applying the word embedding model comprises applying the word embedding model in response to identifying the at least one word collocation in the text corpus and replacing each word collocation of the at least one word collocation in the text corpus with the respective modified unigram.

4. The method of claim 3, wherein generating the candidate list of alternative words for the target word comprises replacing each modified unigram with a respective original word collocation.

5. The method of claim 1, further comprising:
sorting the candidate list of alternative words for the target word based on the Levenshtein distance between the words of each word pair of the filtered set of word pairs;
displaying the sorted candidate list to the user; and
receiving the user's selection of one or more alternative words from the candidate list to be used as alternative text for the target word in the speech recognition engine of the contact center system.

6. The method of claim 1, further comprising automatically selecting, based on the Levenshtein distance between the words of each word pair of the filtered set of word pairs, one or more alternative words from the candidate list as alternative text for the target word in the speech recognition engine of the contact center system.

7. The method of claim 1, further comprising determining a number of occurrences in the text corpus of each word of the filtered set of word pairs.

8. The method of claim 7, wherein generating the candidate list of alternative words for the target word comprises generating the candidate list of alternative words for the target word based on the Levenshtein distance between the words of each word pair of the filtered set of word pairs and the number of occurrences in the text corpus of each word of the filtered set of words.

9. The method of claim 1, further comprising automatically generating a plurality of transcripts of the contact center communication text corpus using greedy decoding.

10. The method of claim 1, further comprising automatically generating a plurality of transcripts of the contact center communication text corpus using prefix-beam decoding.

11. The method of claim 1, wherein generating the candidate list of alternative words for the target word comprises generating the candidate list of alternative words for the target word in response to receiving a user request for alternative words for the target word.

12. A computing system for generating automatic alternative text suggestions for a speech recognition engine of a contact center system, the computing system comprising:
at least one processor; and
at least one memory comprising a plurality of instructions stored thereon that, in response to execution by the at least one processor, causes the computing system to:
apply a word embedding model to generate a vector representation of each unique word in a contact center communication text corpus;
calculate a cosine similarity of each vector representation and each other vector representation generated by the word embedding model;
discard each calculated cosine similarity result determined to be below a predefined threshold to generate a filtered set of word pairs;
calculate a Levenshtein distance between words of each word pair of the filtered set of word pairs; and
generate a candidate list of alternative words for a target word based on the Levenshtein distance between the words of each word pair of the filtered set of word pairs.

13. The computing system of claim 12, wherein the word embedding model comprises a word2vec model.

14. The computing system of claim 12, wherein the plurality of instructions further causes the computing system to identify at least one word collocation in the text corpus and replace each word collocation of the at least one word collocation in the text corpus with a respective modified unigram; and
wherein to apply the word embedding model comprises to apply the word embedding model in response to identification of the at least one word collocation in the text corpus and replacement of each word collocation of the at least one word collocation in the text corpus with the respective modified unigram.

15. The computing system of claim 14, wherein to generate the candidate list of alternative words for the target word comprises to replace each modified unigram with a respective original word collocation.

16. The computing system of claim 12, wherein the plurality of instructions further causes the computing system to:
sort the candidate list of alternative words for the target word based on the Levenshtein distance between the words of each word pair of the filtered set of word pairs;
display the sorted candidate list to the user; and
receive the user's selection of one or more alternative words from the candidate list to be used as alternative text for the target word in the speech recognition engine of the contact center system.

17. The computing system of claim 12, wherein the plurality of instructions further causes the computing system to automatically select, based on the Levenshtein distance between the words of each word pair of the filtered set of word pairs, one or more alternative words from the candidate list as alternative text for the target word in the speech recognition engine of the contact center system.

18. The computing system of claim 12, wherein the plurality of instructions further causes the computing system to determine a number of occurrences in the text corpus of each word of the filtered set of word pairs.

19. The computing system of claim 18, wherein to generate the candidate list of alternative words for the target word comprises to generate the candidate list of alternative words for the target word based on the Levenshtein distance between the words of each word pair of the filtered set of word pairs and the number of occurrences in the text corpus of each word of the filtered set of words.

20. The computing system of claim 12, wherein the plurality of instructions further causes the computing system to automatically generate a plurality of transcripts of the contact center communication text corpus using greedy decoding.
